(19) United States
(12) Patent Application Publication
(10) Pub. No.: US 2007/0153508 A1
(43) Pub. Date: Jul. 5, 2007

(54) Lighting strips with improved manufacturability

(76) Inventors: Jeffrey Nall, Brecksville, OH (US); Tomislav Stimac, Concord, OH (US); Chenyang Li, ShangHai (CN); Matthew Mrakovich, Streetsboro, OH (US); Ronald Brengartner, Strongsville, OH (US)

Correspondence Address: Scott A. McCollister, Esq.;Fay, Sharpe, Fagan, Minnich & McKee, LLP, Seventh Floor, 1100 Superior Avenue, Cleveland, OH, 44114-2579, US

(21) Appl. No.: 11/323,637

(22) Filed: Dec. 30, 2005

(51) Int. Cl. F21S 4/00

(52) U.S. Cl. 362/219

(57) ABSTRACT

In a lighting strip (8, 80, 380), a flexible electrically insulated cable (10, 110, 410) includes spaced apart parallel electrical conductors (12, 14, 112, 114, 118, 412, 414, 418₁, 418₂, 418₃, 418₄) bound together by electrical insulation (16, 116, 416) as a cable. The electrical conductors include power conductors (12, 14, 112, 114, 412, 414). A plurality of lighting units (20, 120, 220, 320, 420) secured to and spaced apart along the flexible electrically insulated cable each include: (i) one or more light emitting devices (24, 124a, 124b, 124c, 124d, 224b1, 224b2, 224b3, 224c1, 224c2, 224c3, 224d1, 224d2, 224d3, 424₁, 424₂, 424₃, 424₄); (ii) power regulating electrical circuitry (40, 140, 240, 340, 440); and (iii) insulation displacing conductors (28, 30, 128a, 128b, 128c, 128d, 130a, 130b, 130c, 130d, 391, 392, 393, 500, 550, 600) connecting the lighting unit with at least the power conductors. The insulation displacing conductors (500, 550, 600) may be interchangeable.

### BACKGROUND

The following relates to the lighting arts. It especially relates to flexible lighting strips for channel lettering, border lighting, and so forth. However, the following will also find application in conjunction with other lighting applications.

Light emitting devices, such as light emitting diodes, are suitable for use in lighting strips. For example, Southard et al., Int'l. Appl. Publ. No. WO 02/097770 A2 illustrates lighting strips including a flexible insulated cable with positive and negative conductors and modules bearing light emitting diodes. Each module includes insulation-displacing conductors that pierce the insulation and make electrical contact with the positive and negative conductors to provide electrical power to the module. By spacing the light emitting diode-bearing modules along the flexible insulated cable, a flexible lighting strip is formed.

Priddy et al., U.S. Pat. No. 6,505,956 illustrate lighting strips formed by daisy-chaining small light emitting diode-bearing printed circuit boards using flexible connecting conductors disposed between the printed circuit boards. Voltage-dividing resistors are included on each printed circuit so that the applied voltage can be larger than the forward voltage of the light emitting diodes. The difference between the applied voltage and the forward voltage of the light emitting diodes is accommodated by heat dissipation in the voltage-dividing resistors. The energy efficiency of such lighting strips is degraded by the power dissipation in the resistors.

Lin, U.S. Pat. No. 5,672,000 discloses a lighting strip including a flexible insulated cable with positive and negative conductors and a third series conductor, and modules bearing light emitting diodes that make electrical contact with the conductors of the insulated cable. A series-parallel lighting strip can be formed having a number of series portions in which each series portion includes a number of spaced apart modules. The first module of a series portion has insulation displacing conductors (IDC's) contacting the positive and series conductors; the next one or more modules have both IDC's connecting with the series conductor; and the last module in the series portion has IDC's contacting the series and negative conductors. The voltage applied between the positive and negative conductors drives the modules of each series portion electrically in series, so that the voltage across the series portion is the sum of the voltages across the modules in the series. Such series-parallel lighting strips can have a relatively high driving voltage and correspondingly lower driving electrical current, thus enabling a longer operable lighting strip length.

However, the lighting strip of Lin has certain disadvantages. The voltage across a given light emitting diode is controlled by the difference in applied driving voltage and by the voltage drops across each module of the series portion containing the given light emitting diode. These voltage drops, in turn, are affected by various factors which may vary with manufacturing variations and/or over time. For example, as the light emitting diodes heat up due to resistive heating during operation, the effective forward voltage increases due to a heat-induced increase in electrical resistance. If one of the modules fails, the remaining light emitting diodes will experience changed driving voltage.

More generally, existing lighting strips are sensitive to component variations. For example, in addition to the above-mentioned heating and light emitting diode failure issues, the present inventors have found that variability of forward voltage values in commercial lots of light emitting diodes is large enough that not all the light emitting diodes can be used in a parallel or series-parallel lighting strip such as that of Lin. Light emitting diodes at the high and low ends of the forward voltage range must be discarded, since their inclusion in a parallel or series portion or a series-parallel lighting strip would produce an unacceptable redistribution of voltage.

Another manufacturing issue with existing lighting strips is the number of different parts involved in lighting strip construction. Typically, the lighting strip includes light emitting devices, connectors, and two or more different types of insulation displacing conductors (IDC's). This multiplicity of different types of parts complicates manufacturing including the stocking of parts for the lighting strip.

### BRIEF SUMMARY

According to one aspect, a lighting strip is disclosed. A flexible electrically insulated cable includes a plurality of spaced apart parallel electrical conductors bound together by electrical insulation as a cable. The electrical conductors include at least first and second power conductors. A plurality of lighting units are secured to and spaced apart along the flexible electrically insulated cable. Each lighting unit includes: (i) one or more light emitting devices; (ii) power regulating electrical circuitry configured to regulate electrical power delivered to the lighting unit from the power conductors of the cable; and (iii) insulation displacing conductors connecting the lighting unit with at least the first and second power conductors.

According to another aspect, a lighting strip is disclosed. A flexible electrically insulated cable includes a plurality of spaced apart parallel electrical conductors bound together by electrical insulation as a cable. The electrical conductors include at least first and second power conductors. A plurality of lighting units are secured to and spaced apart along the flexible electrically insulated cable. Each lighting unit includes: (i) one or more light emitting devices; and (ii) a plurality of interchangeable insulation displacing conductors connecting the lighting unit with at least the first and second power conductors.

Numerous advantages and benefits of the present invention will become apparent to those of ordinary skill in the art upon reading and understanding the present specification.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1A diagrammatically shows a segment of a parallel lighting strip.

FIG. 1B shows an equivalent electrical circuit diagram using a constant current or constant voltage driver integrated circuit chip for one of the lighting units of the parallel lighting strip of FIG. 1.

FIG. 2A diagrammatically shows a lighting unit of a series/parallel lighting strip.

FIG. 2B diagrammatically shows a portion of the series/parallel lighting strip including three lighting units.

FIG. 3A shows an equivalent electrical circuit diagram for the first terminating connector of the lighting unit of FIG. 2A on which the power regulating circuitry is disposed.

FIG. 3B shows an equivalent electrical circuit diagram for the first series connector of the lighting unit of FIG. 2A.

FIG. 3C shows an equivalent electrical circuit diagram for the second series connector of the lighting unit of FIG. 2A.

FIG. 3D shows an equivalent electrical circuit diagram for the second terminating connector of the lighting unit of FIG. 2A.

FIG. 4 diagrammatically shows another lighting unit suitable for use in a series/parallel lighting strip.

FIG. 5A shows an equivalent electrical circuit diagram for the first terminating connector of the lighting unit of FIG. 4 on which the power regulating circuitry is disposed.

FIG. 5B shows an equivalent electrical circuit diagram for the first series connector of the lighting unit of FIG. 4.

FIG. 6A diagrammatically shows another lighting unit embodiment for a series/parallel lighting strip.

FIG. 6B diagrammatically shows a series/parallel lighting strip constructed by repetitions of the lighting unit of FIG. 6A.

FIG. 7A shows an equivalent electrical circuit diagram for the first terminating connector of the lighting unit of FIG. 6A on which the power regulating circuitry is disposed.

FIG. 7B shows a suitable physical layout for the power regulating circuitry of the first terminating connector of the lighting unit of FIG. 6A.

FIG. 8 shows the printed circuit board supporting the power regulating circuitry of the first terminating connector of the lighting unit of FIG. 6A secured by friction-fit to insulating displacing conductors (IDC's) of the first terminating connector.

FIG. 9 diagrammatically shows another lighting unit embodiment for a series/parallel lighting strip including four independently driven series lines.

FIG. 10 shows an interchangeable insulation displacing conductor (IDC) suitable for connecting a printed circuit board with any of three conductors of a three-conductor flexible electrically insulated cable.

FIGS. 11-13 show how the interchangeable IDC of FIG. 10 is used to connect the printed circuit board with any of the three conductors of the three-conductor flexible electrically insulated cable.

FIG. 14 shows selectable connection of another interchangeable insulation displacing conductor (IDC) with either of two conductors of a two-conductor flexible electrically insulated cable.

FIG. 15 shows selectable connection of yet another interchangeable insulation displacing conductor (IDC) with any of three conductors of a three-conductor flexible electrically insulated cable.

### DETAILED DESCRIPTION OF PREFERRED EMBODIMENTS

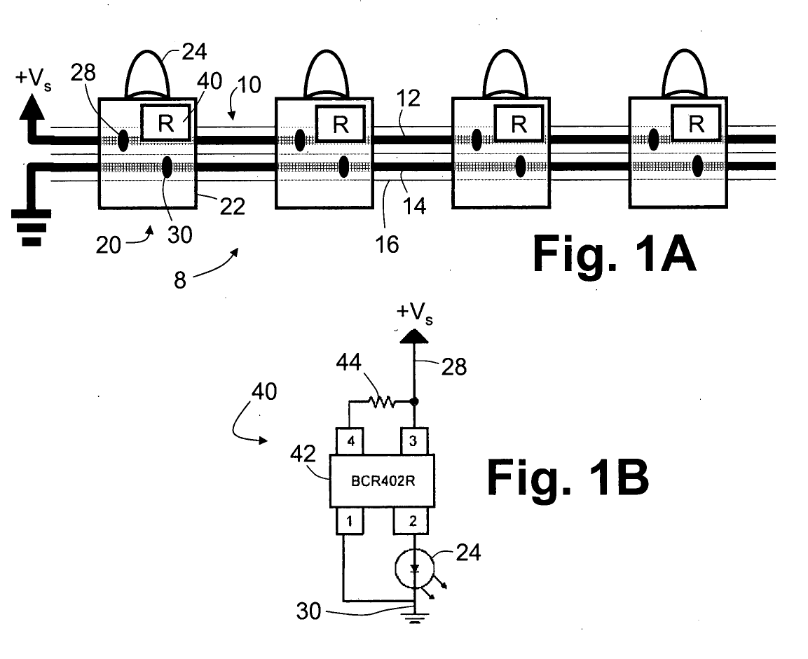

With reference to FIGS. 1A and 1B, a parallel lighting strip 8 includes a flexible electrically insulated cable 10 having first and second power conductors 12, 14 electrically isolated from one another and bound together as a cable by electrical insulation 16. In the lighting strip 8, the first power conductor 12 is connected to a positive voltage denoted Vₛ while the second power conductor 14 is connected to electrical ground, thus producing a potential difference of Vₛ between the power conductors 12, 14. In other embodiments, a differential voltage can be applied, for example by applying +Vₛ/2 to the conductor 12 and −Vₛ/2 to the conductor 14 to produce a potential difference of Vₛ between the power conductors 12, 14. In yet other embodiments, an a.c. single-ended or differential voltage can be applied to the power conductors 12, 14.

The lighting strip 8 further includes a plurality of lighting units 20. Four lighting units are shown; however, only the leftmost lighting unit 20 is labeled with reference numbers in FIG. 1A. Each lighting unit 20 includes a connector 22 on which is disposed a light emitting device 24, such as a light emitting diode, miniature incandescent lamp, or so forth. Each connector 22 includes a first insulation displacing conductor 28 that electrically contacts the first power conductor 12, and a second insulation displacing conductor 30 that electrically contacts the second power conductor 14. The insulation displacing conductors 28, 30 displace the electrical insulation 16 to electrically contact the power conductors 12, 14. Power regulating circuitry 40 is also disposed on or in each of the connectors 22 so that each lighting unit 20 has its own electrical power regulation.

With particular reference to FIG. 1B which shows an electrical schematic representation of one of the lighting units 20. Each of the lighting units 20 includes the power regulating circuitry 40 which in the illustrated embodiment of FIGS. 1A and 1B includes an integrated circuit power regulator component 42 and a passive resistor 44 interconnected with the integrated circuit power regulator component 42 such that the integrated circuit power regulator component produces one of a constant current output and a constant voltage output. In the illustrated embodiment, the integrated circuit power regulator component 42 is a BCR402R LED driver (available from Infineon Technologies AG, Munich, Germany) that outputs a constant current between output pin 2 and ground with the current level controlled by the resistor 44 connected between pins 3 and 4. Input pin 3 is also connected to the first power conductor 12 via the first insulation displacing conductor 28 to receive input voltage Vₛ. The light emitting device 24 is electrically connected between the output pin 2 and the ground potential provided by the second power conductor 14 via the second insulation displacing conductor 30. The resistor 44 is selected to provide the desired regulated constant current level.

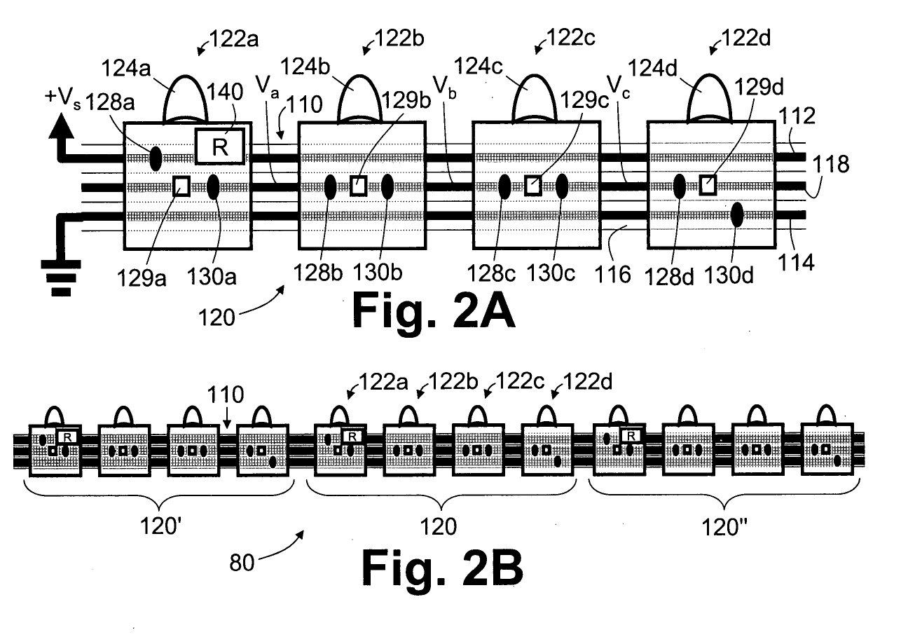

With reference to FIGS. 2A and 2B, a series-parallel lighting strip 80 includes a flexible electrically insulated cable 100 having first and second power conductors 112, 114 electrically isolated from one another and bound together as a cable by electrical insulation 116. Unlike the cable 10, the cable 100 includes a third series conductor 118. In the lighting strip 80, the first power conductor 112 is connected to a positive voltage denoted Vₛ while the second power conductor 114 is connected to electrical ground, thus producing a potential difference of Vₛ between the power conductors 112, 114. In other embodiments, a differential voltage can be applied, or an a.c. single-ended or differential voltage can be applied to the power conductors 112, 114.

The lighting strip 80 further includes a plurality of lighting units 120. Each lighting unit 120 includes a plurality of sub-units supported or housed by connectors 122a, 122b, 122c, 122d. Light emitting devices 124a, 124b, 124c, 124d are disposed on the connectors 122a, 122b, 122c, 122d, respectively. The connector 122a is a first terminating connector and includes a first electrically insulation displacing conductor 128a that electrically contacts the first power conductor 112, and a second insulation displacing conductor 130a that electrically contacts the series conductor 118. An interruption 129a in the series conductor 118 arranged to the left of the insulation displacing conductor 130a electrically isolates the lighting unit 120 from a neighboring lighting unit 120′ to the left of the lighting unit 120 (see FIG. 2B).

The connector 122b is a series connector and includes first and second insulation displacing conductors 128b, 130b that electrically contact the series conductor 118. An interruption 129b in the series conductor 118 arranged between the insulation displacing conductors 128b, 130b electrically isolates the insulation displacing conductors 128b, 130b from one another. The connector 122c is another series connector and includes first and second insulation displacing conductors 128c, 130c that electrically contact the series conductor 118. An interruption 129c in the series conductor 118 arranged between the insulation displacing conductors 128c, 130c electrically isolates the insulation displacing conductors 128c, 130c from one another.

The connector 122d is a second terminating connector and includes a first insulation displacing conductor 128d that electrically contacts the series conductor 118, and a second insulation displacing conductor 130d that electrically contacts the second power conductor 114. An interruption 129d in the series conductor 118 arranged to the right of the insulation displacing conductor 128d electrically isolates the lighting unit 120 from a neighboring lighting unit 120″ to the right of the lighting unit 120 (see FIG. 2B). The skilled artisan will recognize from FIG. 2B that inclusion of both interruptions 129a, 129d is redundant, and that one or the other can optionally be omitted. Both interruptions are optionally included in the design for simplicity during manufacturing and symmetry in design. The series connectors 122b, 122c are arranged between the terminating connectors 122a, 122d.

With continuing reference to FIGS. 2A and 2B, the interruptions 129a, 129d electrically isolate the portion of the series conductor 118 corresponding with the lighting unit 120 from portions of the series conductor 118 to the left and right of the lighting unit 120. The interruptions 129b, 129c provide for three stepped voltage levels, labeled Vₐ, V_{b}, and V_{c} in FIG. 2A, along the portion of the electrically disjointed series conductor 118 demarcated by the interruptions 129a, 129d. The voltage Vₐ is present along that portion of the series conductor 118 lying between the interruptions 129a, 129b, that is, between the connectors 122a, 122b. The voltage V_{b} is present along that portion of the series conductor 118 lying between the interruptions 129b, 129c, that is, between the connectors 122b, 122c. The voltage V_{c} is present along that portion of the series conductor 118 lying between the interruptions 129c, 129d, that is, between the connectors 122c, 122d. The lighting unit 120 has its connectors 122a, 122b, 122c, 122d connected in series between the power conductors 112, 114, with the series sequence being:
+Vₛ-122a-Vₐ-122b-V_{b}-122c-V_{c}-122d-Ground
where the reference numbers 122a, 122b, 122c, 122d in the above sequence denote the relative positions of the connectors 122a, 122b, 122c, 122d in the electrical series interconnection of the lighting unit 120.

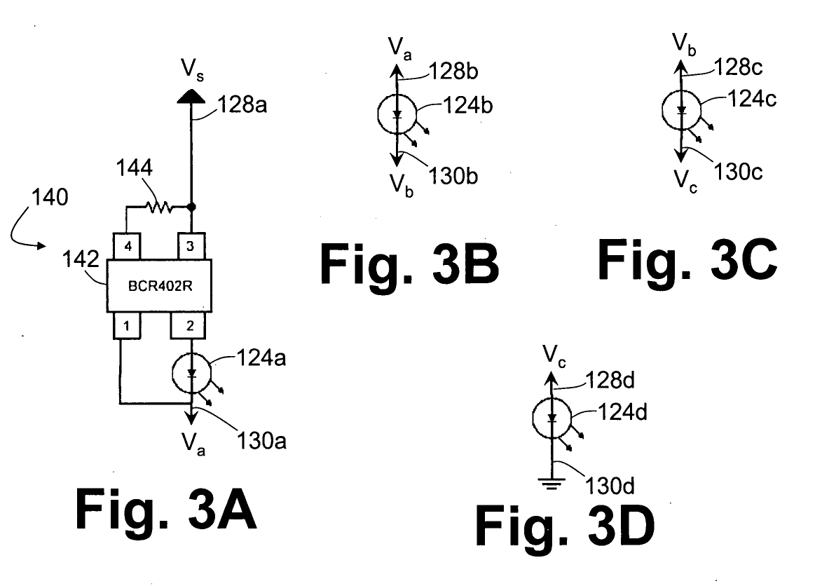

FIGS. 3A, 3B, 3C, and 3D show electrical schematic representations of the connectors 122a, 122b, 122c, 122d, respectively. Power regulating circuitry 140 is disposed on or in the first terminating connector 122a to provide power regulation for the lighting unit 120. Because the four connectors 122a, 122b, 122c, 122d are connected in series, there is no power regulating circuitry for the remaining three connectors 122b, 122c, 122d. Rather, the power regulating circuitry 140 produces a common constant current level that flows through all four connectors 122a, 122b, 122c, 122d. In the illustrated embodiment of FIG. 3A, the power regulating circuitry 140 includes an integrated circuit power regulator component 142 and a passive resistor 144 interconnected with the integrated circuit power regulator component 142 such that the integrated circuit power regulator component produces one of a constant current output and a constant voltage output. In the illustrated embodiment, the integrated circuit power regulator component 142 is a BCR402R LED driver (available from Infineon Technologies AG, Munich, Germany) that outputs a constant current between output pin 2 and ground with the current level controlled by the resistor 144 connected between pins 3 and 4. Input pin 3 is also connected to the first power conductor 112 via the first insulation displacing conductor 128a to receive input voltage Vₛ. The light emitting device 124a is electrically connected between the output pin 2 and the ground potential provided by the second power conductor 114 via the second insulation displacing conductor 130a. The resistor 144 is selected to provide the desired regulated constant current level.

The constant current flow provided by the power regulating circuitry 140 can drive substantially any number of connectors arranged electrically in series. Thus, while the illustrated lighting unit 120 includes two series connectors 122b, 122c, the series can include no series connectors, one series connector, or more than two series connectors. The number of series connectors in the lighting unit is limited by the loading capability of the selected power regulating circuitry disposed on the first terminating connector of the series.

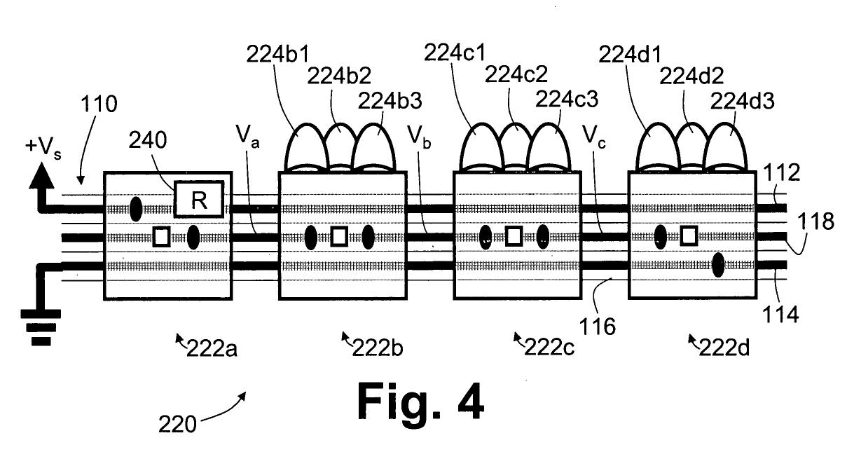

With reference to FIG. 4, another lighting unit 220 for a series-parallel lighting strip is similar to the lighting unit 120, and includes the flexible electrically insulated cable 100 having the first and second power conductors 112, 114 connected with a voltage Vₛ and electrical ground respectively, the electrical insulation 116, and the series conductor 118. The lighting unit 220 further includes a plurality of series connected sub-units supported or housed by connectors 222a, 222b, 222c, 222d that are series-interconnected similarly to the series connectors 122a, 122b, 122c, 122d of the lighting strip 80.

The lighting unit 220 differs from the lighting unit 120 in the arrangement of light emitting devices on the connectors 222a, 222b, 222c, 222d. In the lighting unit 220, the first terminating connector 222a has no light emitting devices disposed thereon. Rather, the connector 222a serves only as a power-regulating component of the lighting unit 220. The remaining connectors 222b, 222c, 222d each have three light emitting devices disposed thereon. The connector 222b has light emitting devices 224b1, 224b2, 224b3 disposed thereon; the connector 222c has light emitting devices 224c1, 224c2, 224c3 disposed thereon; and the connector 222d has light emitting devices 224d1, 224d2, 224d3 disposed thereon.

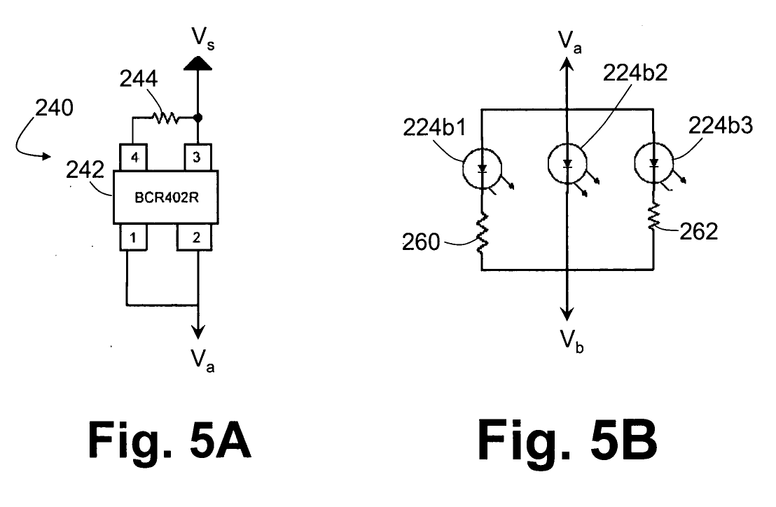

With continuing reference to FIG. 4 and with further reference to FIGS. 5A and 5B which show electrical schematic representations of the connectors 222a, 222b, respectively, power regulating circuitry 240 is disposed on or in the first terminating connector 222a to provide power regulation for the lighting unit 220. The power regulating circuitry 240 shown in FIG. 5A is substantially similar to the power regulating circuitry 140 shown in FIG. 3A, and includes a BCR402R IC 242 and tuning resistor 244. However, since the connector 222a has no light emitting devices, the constant current output from pin 2 of the BCR402R integrated circuit goes directly to the portion of the electrically disjointed series conductor 118 at which the voltage Vₐ is present. As shown in FIG. 5B, the three light emitting devices 224b1, 224b2, 224b3 of the series connector 222b are electrically connected in parallel. In the illustrated embodiment, voltage dividing resistors 260, 262 provide that the voltages across each of the light emitting devices 224b1, 224b2, 224b3 is in general different. This is advantageous if, for example, the light emitting devices 224b1, 224b2, 224b3 are red-, green-, and blue-light emitting devices having different forward voltages and providing a composite white light output. The circuitry of FIG. 5B is an example; other interconnections of multiple light emitting devices can be used. In some embodiments, the multiple light emitting devices on a single connector may be interconnected in series, so that every light emitting device in the lighting unit receives current at the same controlled constant current level. Moreover, different connectors in the lighting unit can have different electrical configurations.

The illustrated power regulating circuitry 40, 140, 240 are examples. Those skilled in the art can readily modify the illustrated circuitry 40, 140, 240, for example by replacing the BCR402R LED driver with another integrated circuit power regulator, changing the tuning passive circuit components, or so forth. In some other contemplated embodiments, for example, an LM317 Adjustable Regulator (available from National Semiconductor Corporation, Arlington, Texas) is used as the integrated circuit power regulator. The LM317 can be configured to provide either constant current or constant voltage power regulation. The selected power regulating circuitry preferably has a small footprint to enable the supporting connectors 22, 122a, 222a to be kept small. However, since the first terminating connector 222a of the lighting unit 220 does not support any light emitting devices, the footprint of the power regulating circuitry 240 of the lighting unit 220 can be relatively larger than the footprint of the power regulating circuitry 140 of the lighting unit 120.

It will be appreciated that the power regulating circuitry can be disposed on any of the modules of the series-connected lighting unit, such as on the first terminating connector as illustrated, or on the second terminating connector, or on one of the series connectors. Moreover, in some embodiments power regulating circuitry may be distributed over more than one connector. For example, constant-current power regulation circuitry may be disposed on the first terminating connector, while overload safety circuitry may be disposed on the second terminating connector.

The example illustrated power regulating circuitry 40, 140, 240 each output a constant driving electrical current. Constant current operation is generally preferred for light emitting devices such as light emitting diodes, since light output at constant current is less temperature-dependent than light output at constant voltage. Thus, as the light emitting devices heat up due to heat dissipation during operation, the constant current operation maintains light output at a substantially constant level.

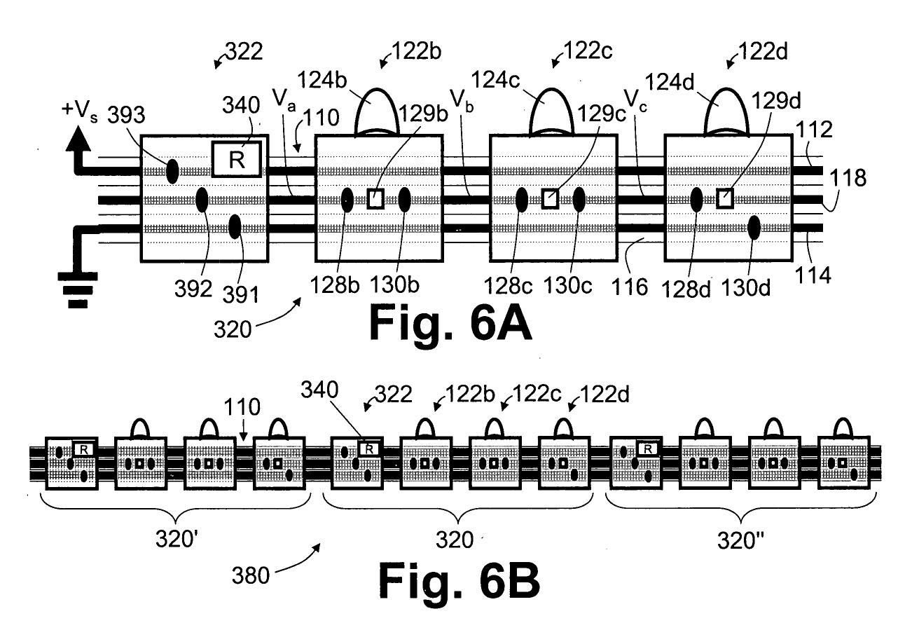

With reference to FIGS. 6A and 6B, a modified version 320 of the lighting unit 120 of FIG. 2A and a modified version 380 of the series-parallel lighting strip 80 of FIG. 2B, respectively, is illustrated. The lighting unit 320 differs from the lighting unit 120 by a first terminating sub-unit or connector 322 substituting for the first terminating sub-unit or connector 122a that (i) omits the light emitting device 124a and the interruption 129a, and (ii) has modified power regulating circuitry 340 that is connected with the ground conductor 114.

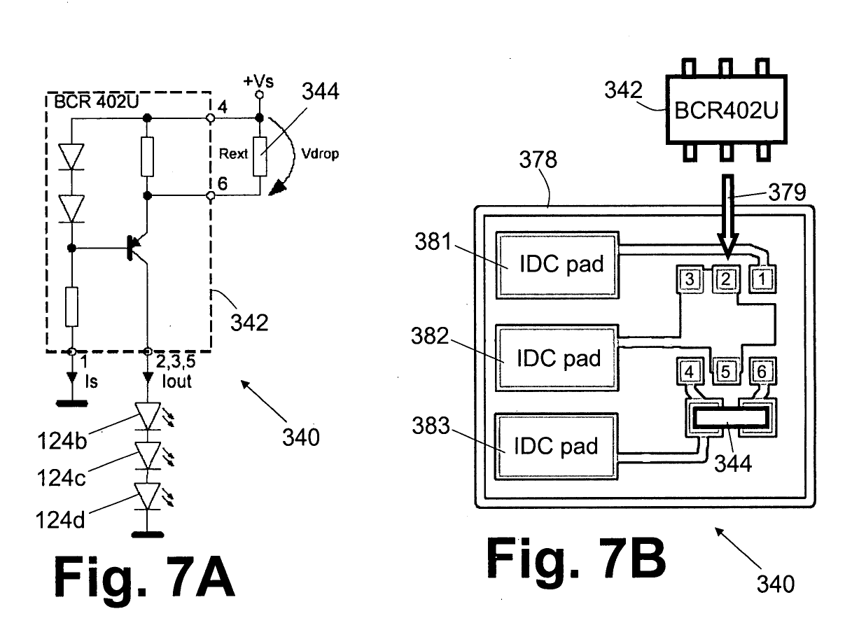

With reference to FIGS. 7A and 7B, the power regulating circuitry 340 employs the BCR402U integrated circuit (IC) 342 whose functional electrical diagram is shown in FIG. 7A, and whose six-pin dual in-line package (DIP) configuration is shown in FIG. 7B. A discrete resistor component 344 is connected between pins four and six of the DIP package BCR402U IC 342. The pins of the DIP package BCR402U IC 342 are suitably soldered to a corresponding set of six pads, or insert into a six-pin DIP socket, of a printed circuit board 378 (soldering or DIP package socket insertion diagrammatically indicated in FIG. 7B by arrow 379). As shown, the printed circuit board 378 includes printed circuitry for connecting the soldered or inserted pins of the DIP package BCR402U IC 342 to the resistor 344 and to electrical contact pads 381, 382, 383. Printed circuitry connects the electrical contact pad 381 connects with ground pin 1 of the BCR402U IC 342. Printed circuitry connects the electrical contact pad 382 connects with pins 2, 3, and 5 of the BCR402U IC 342. Printed circuitry connects the electrical contact pad 383 connects with pin 4 of the BCR402U IC 342, and defines solder pads for soldering the discrete resistor 344 across pins 4 and 6 of the BCR402U IC 342.

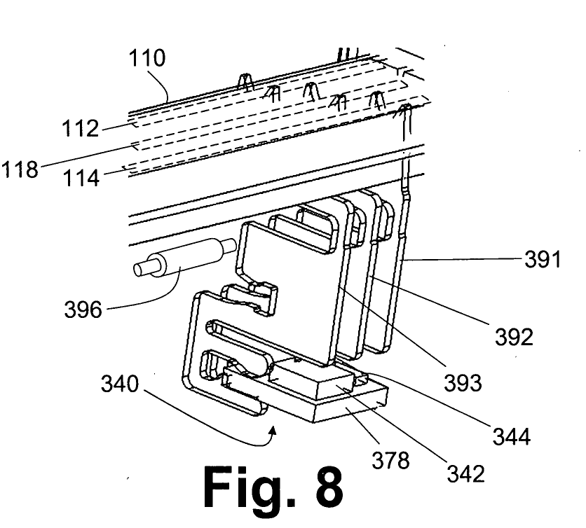

With continuing reference to FIGS. 6A, 6B, 7A, and 7B, and further reference to FIG. 8, the printed circuit board 378 is frictionally held by insulation-displacing connectors (IDC's) 391, 392, 393 of the first terminating connector 322. In the illustrated embodiment, the electrical contact pads 381, 382, 383 of the printed circuit board 378 connect with corresponding friction-securing slots of the respective IDC's 391, 392, 393, respectively, of the module. The IDC's 391, 392, 393 connect with the three-conductor cable 110 by insulation displacement connection, so that pin 1 of the BCR402U IC 342 is connected with the electrical ground conductor 114, pin 4 of the BCR402U IC 342 is connected with the electrical conductor 112 carrying the voltage +Vₛ, and pins 2, 3, and 5 of the BCR402U IC 342 is connected with the third series conductor 118. With particular reference to FIG. 6B, it will be noted that the interruption 129d of the second terminating connector 122d provides electrical isolation between the lighting unit 320 and a subsequent identical lighting unit 320″, while a previous identical lighting unit 320′ is electrically isolated from the lighting unit 320 by the interruption 129d of the previous identical lighting unit 320′. Optionally, a discrete zener diode component 396 is friction held by friction-securing slots of the IDC's 391, 393 to provide current-limiting protection for the power regulating circuitry 340. (In FIG. 8, the zener diode 396 is shown detached from the friction-securing slots for improved visibility). Similarly, a discrete zener diode component (not shown) can be placed across the insulation displacing conductors 128b, 130b of the connector 122b, or so forth, to provide current limiting protection for each module of the lighting unit 320. Placing a zener diode across each light emitting device 124b, 124c, 124d in this manner also advantageously enables the lighting unit 320 to continue operating if one of the light emitting devices 124b, 124c, 124d fails.

FIG. 8 shows one suitable physical layout for power regulating circuitry. In other embodiments, the printed circuit board may be soldered to the insulation displacing conductors of the sub-unit. Manufacturability is enhanced by disposing the power regulating circuitry on a printed circuit board that is soldered, friction-fit, or otherwise electrically connected with slots of the IDC's 391, 392, 393. If a different type of LED is employed in the lighting unit, then this is readily accommodated by using a different power regulating circuitry board that solders or fits into the IDC's 391, 392, 393. It will also be appreciated that other power regulatory functions besides current limiting can be performed. For example, if the power conductors carry a.c. power, then the power regulating circuitry can include half-wave or full-wave rectification circuitry.

It will be appreciated that each lighting unit can in general have different power regulating circuitry. For example, in the series-parallel lighting strip 380 of FIG. 6B, the lighting units 320′, 320″ can optionally include red light emitting diodes and power regulating circuitry suitable for driving red light emitting diodes, while the lighting unit 320 can include white light emitting diodes and power regulating circuitry suitable for driving white light emitting diodes (whose power requirements may be different from the power requirements of the red light emitting diodes of the lighting units 320′, 320″). In this way, a red-and-white colored lighting strip is generated.

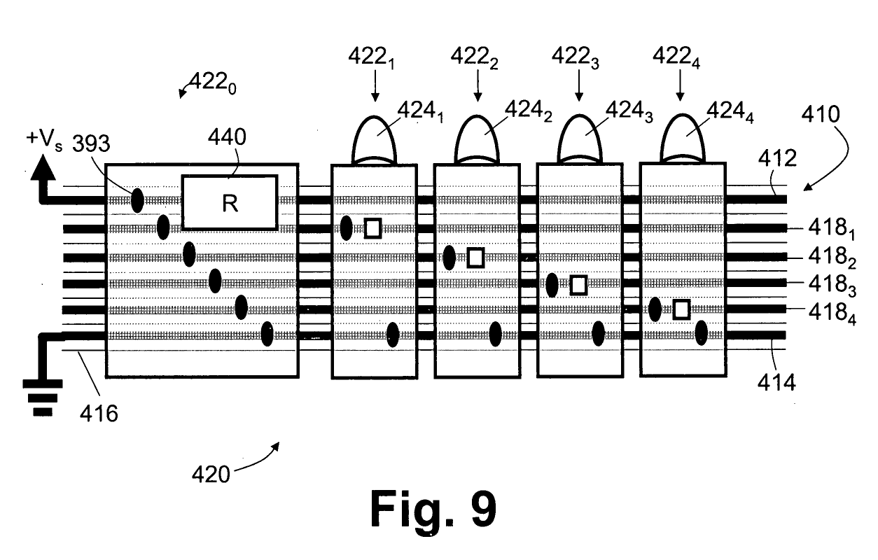

With reference to FIG. 9, the arrangement of FIGS. 6A, 6B, 7A, 7B, and 8 is readily extended to a lighting unit 420 having more than one power-regulated electrical series in the same lighting unit. In FIG. 9, a flexible electrically insulated cable 410 includes first and second power conductors 412, 414 carrying, for example, +Vₛ and ground electrical potential, respectively, bound together as a cable by insulation 416. The cable 410 further includes four series conductors 418₁, 418₂, 418₃, 418₄ also bound by the insulation 416. A first terminating sub-unit 422₀ includes power regulating circuitry 440 which provides independent and generally different regulated power to each of the four series conductors 418₁, 418₂, 418₃, 418₄. For example, the power regulating circuitry 440 may include four circuits such as are shown in FIG. 7A, each having different values for the resistance 344 to provide different regulated power. The four circuits can be disposed on a common circuit board similar to that shown in FIG. 7B, except that the common circuit board includes space for four BCR402U DIP packages and includes six IDC pads for friction-fit to six IDC connectors that connect with the six conductors 412, 414, 418₁, 418₂, 418₃, 418₄ of the cable 410. In this way, each of the four series conductors 418₁, 418₂, 418₃, 418₄ is independently driven.

The lighting unit 420 further includes four terminating sub-units supported and/or housed by connectors 422₁, 422₂, 422₃, 422₄. The terminating connector 422₁ includes a first insulation displacing conductor connected with the series conductor 418₁ and a second insulation displacing conductor connected with the ground conductor 414. An interruption in the series conductor 418₁ at the terminating connector 422₁ provides isolation along the series conductor 418₁ of the lighting unit 420 from neighboring lighting units. A light emitting device 424₁ is disposed on the terminating connector 422₁ and receives conditioned electrical power from the series conductor 418₁. The terminating connector 422₂ includes a first insulation displacing conductor connected with the series conductor 418₂ and a second insulation displacing conductor connected with the ground conductor 414. An interruption in the series conductor 418₂ at the terminating connector 422₂ provides isolation along the series conductor 418₂ of the lighting unit 420 from neighboring lighting units. A light emitting device 424₂ is disposed on the terminating connector 422₁ and receives conditioned electrical power from the series conductor 418₂. The terminating connector 422₃ includes a first insulation displacing conductor connected with the series conductor 418₃ and a second insulation displacing conductor connected with the ground conductor 414. An interruption in the series conductor 418₃ at the terminating connector 422₃ provides isolation along the series conductor 418₃ of the lighting unit 420 from neighboring lighting units. A light emitting device 424₃ is disposed on the terminating connector 422₃ and receives conditioned electrical power from the series conductor 418₃. The terminating connector 422₄ includes a first insulation displacing conductor connected with the series conductor 418₄ and a second insulation displacing conductor connected with the ground conductor 414. An interruption in the series conductor 418₄ at the terminating connector 422₄ provides isolation along the series conductor 418₄ of the lighting unit 420 from neighboring lighting units. A light emitting device 424₄ is disposed on the terminating connector 422₄ and receives conditioned electrical power from the series conductor 418_{4.}

Advantageously, the light emitting devices 424₁, 424₂, 424₃, 424₄ are each independently driven by the four respective series conductors 418₁, 418₂, 418₃, 418₄, providing substantial versatility in design. Moreover, the driving circuitry for each of the four series conductors 418₁, 418₂, 418₃, 418₄ contained in the first terminating connector 422₀ optionally includes other features such as timed flashing. Optionally, one or more series sub-units (not shown) can also be included on each series conductor line between the first terminating sub-unit 422₀ and the terminating sub-unit 422₁, 422₂, 422₃, 422₄ for that series conductor.

An advantage of disposing power regulating electrical circuitry with each lighting unit, as opposed to employing power regulating circuitry operating on the lighting strip as a whole, is that the per-lighting unit power regulating circuitry can compensate for variations in resistance, failure of one or a few light emitting devices, or other localized variations in the electrical properties of the lighting strip. For example, constant current regulating circuitry applied to the lighting strip as a whole can compensate to a limited degree for a longer lighting strip by increasing voltage. However, constant current regulating circuitry applied to the lighting strip as a whole cannot compensate locally for the voltage drop along the strip. In contrast, by having constant current regulating circuitry disposed with and regulating each lighting unit, such voltage drop along the strip is readily compensated. Similarly, failure of a single light emitting device within a lighting unit typically will have a negligible effect on the lighting strip as a whole, and hence will not be compensated by power regulating circuitry applied to the lighting strip as a whole. On the other hand, power regulating circuitry associated with the lighting unit containing the failed light emitting device provides suitable compensation for the failed light emitting device.

In the illustrated embodiments, each lighting unit employs one or more sub-units in which each sub-unit includes a connector directly or indirectly supporting and/or housing the IDC's, light emitting devices, and power regulating circuitry. In some embodiments, it is contemplated to omit the connectors. For example, each sub-unit can be assembled by connecting the IDC's to the flexible electrically insulated cable, installing the optional printed circuit board and light emitting devices on the IDC's, and molding a light-transmissive material over the assembled sub-unit. Such assembly processing is readily automated. If the light strip is to be installed in a protected environment such as the inside of a channel letter, then both the connector and the molding is optionally omitted.

With returning reference to FIG. 8, a manufacturing complication is introduced by the insulation displacing conductors (IDC's) 391, 392, 393. These three types of IDC's are not interchangeable—rather, the IDC 391 must be used to connect with the conductor 114; the IDC 392 must be used to connect with the conductor 118; and the IDC 393 must be used to connect with the conductor 112. The use of three different types of IDC's arises because a different positioning of the insulation-displacing prong is called for in contacting each of the three parallel spaced apart conductors 112, 114, 118 of the flexible electrically insulating cable 110. IDC's 391, 392, 393 each have a different shape, and are not interchangeable. For mass manufacturing of lighting strips, a sufficient number of each type of IDC 391, 392, 393 must be kept in stock for the manufacturing. The “sufficient number” can be difficult to estimate, since lighting strips with relatively more series connectors may use relatively more of the IDC's 392.

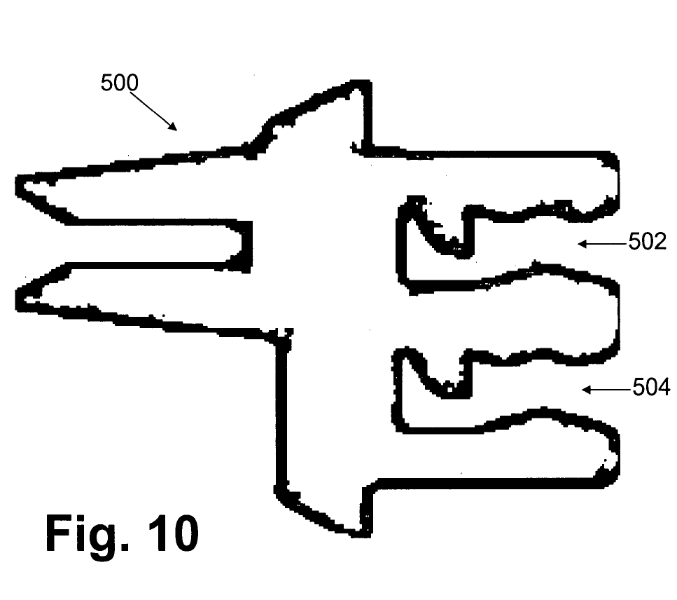

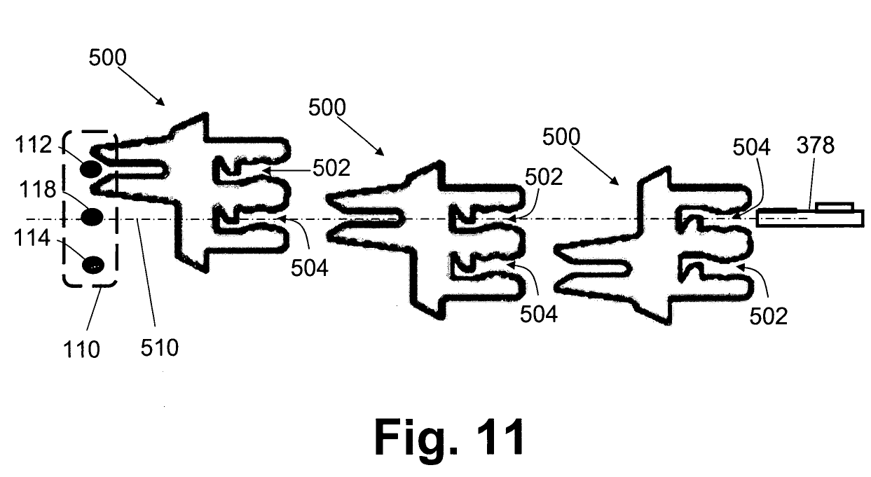

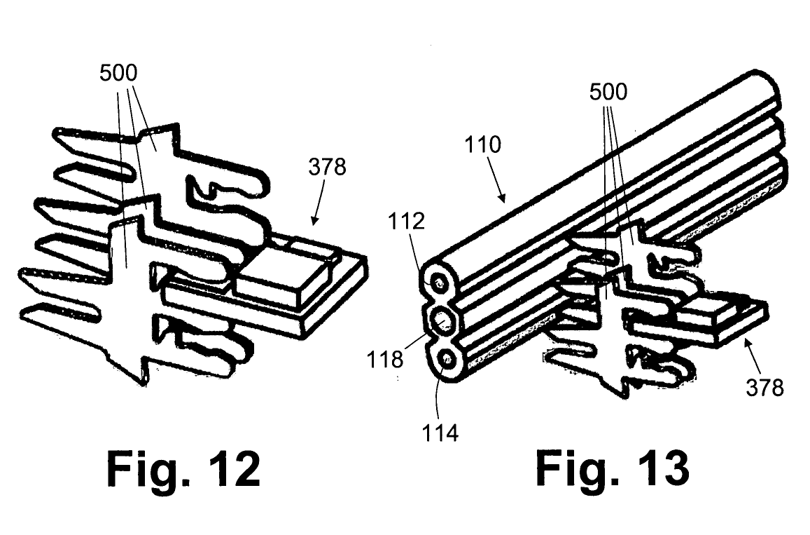

With reference to FIGS. 10-13, an alternative interchangeable insulation displacing conductor (IDC) 500 is suitably substituted for the three different types of IDC's 391, 392, 393. The same interchangeable IDC 500 can be used to connect the printed circuit board 378 with any of the three conductors 112, 114, 118 of the flexible electrically insulated cable 110. The interchangeable IDC 500 includes two slots 502, 504 for receiving the printed circuit board 378. FIGS. 11-13 show how the single interchangeable type of IDC 500 can connect the printed circuit board 378 with any of the three conductors 112, 114, 118 of the flexible electrically insulated cable 110. For connection to the conductor 112, the lower slot 504 is mated to the printed circuit board 378. For connection to the series conductor 118, the upper slot 502 is mated to the printed circuit board 378. For connection to the conductor 114, the upper slot 502 is mated to the printed circuit board 378 with the IDC 500 flipped respective to its position when connecting with the series conductor 118. (In FIG. 11, a dot-dashed horizontal line 510 indicates the position or elevation of the printed circuit board 378.) Thus, only the single type of IDC 500 is kept in stock, and can be interchangeably used to connect the printed circuit board 378 with any of the three conductors 112, 114, 118 of the flexible electrically insulated cable 110.

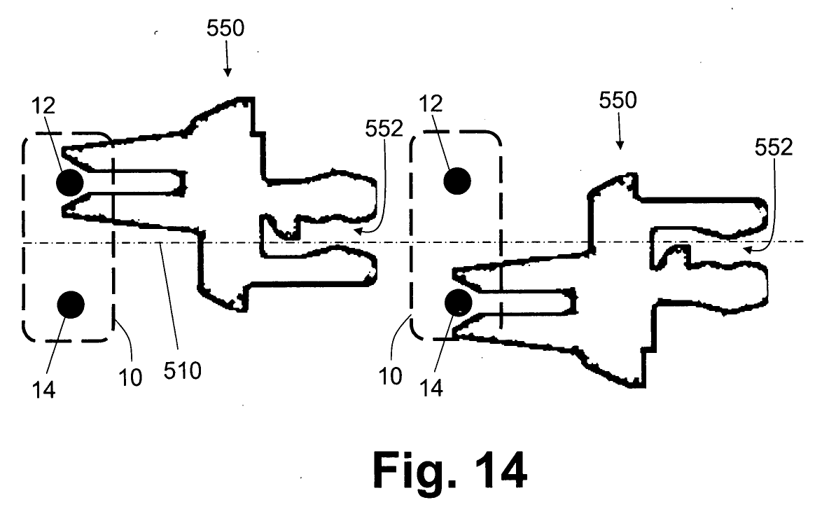

With reference to FIG. 14, another embodiment of an interchangeable insulation displacing conductor (IDC) 550 is suitable for connecting to either conductor 12, 14 of the two-conductor flexible electrically insulated cable 10. Here, only a single slot 552 is provided for mating with the printed circuit board, and connection to either conductor 12, 14 is achieved by flipping the IDC 550. (In FIG. 14, the dot-dashed horizontal line 510 again indicates the position or elevation of the printed circuit board 378.)

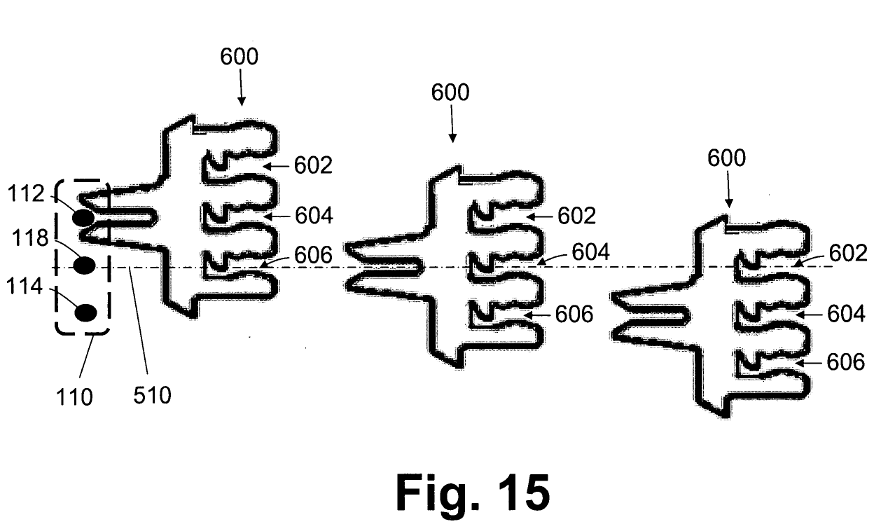

With reference to FIG. 15, another embodiment of an interchangeable insulation displacing conductor (IDC) 600 is suitable for connecting to any conductor 112, 114, 118 of the three-conductor flexible electrically insulated cable 110. Here, three slot 602, 604, 606 are provided for mating with the printed circuit board, and connection to any conductor 112, 114, 116 is achieved by using the appropriate one of the three slots 602, 604, 606. (In FIG. 15, the dot-dashed horizontal line 510 again indicates the position or elevation of the printed circuit board 378.)

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A lighting strip comprising:
a flexible electrically insulated cable including a plurality of spaced apart parallel electrical conductors bound together by electrical insulation as a cable, the electrical conductors including at least first and second power conductors; and
a plurality of lighting units secured to and spaced apart along the flexible electrically insulated cable, each lighting unit including (i) one or more light emitting devices, (ii) power regulating electrical circuitry configured to regulate electrical power delivered to the lighting unit from the power conductors of the cable, and (iii) insulation displacing conductors connecting the lighting unit with at least the first and second power conductors.

2. The lighting strip as set forth in claim 1, wherein each lighting unit is distributed along the flexible electrically insulated cable as a plurality of sub-units electrically configured as at least one electrical series by a corresponding series conductor of the plurality of spaced apart parallel electrical conductors.

3. The lighting strip as set forth in claim 2, wherein the power regulating electrical circuitry is configured to maintain a constant current in the at least one electrical series.

4. The lighting strip as set forth in claim 1, wherein the power regulating electrical circuitry of each lighting unit comprises:
constant-current regulating circuitry that maintains a constant electrical current flowing through the lighting unit.

5. The lighting strip as set forth in claim 1, wherein each lighting unit further comprises:
a printed circuit board on which at least the power regulating electrical circuitry is disposed.

6. The lighting strip as set forth in claim 5, wherein the power regulating electrical circuitry of each lighting unit includes:
an integrated circuit power regulator component; and
at least one passive circuit element interconnected with the integrated circuit power regulator component via printed circuitry of the printed circuit board such that the integrated circuit power regulator component produces one of a constant current output and a constant voltage output.

7. The lighting strip as set forth in claim 5, wherein the printed circuit board is secured in friction-securing slots of the insulation displacing conductors with electrical contact pads of the printed circuit board electrically contacting the insulation displacing conductors.

8. The lighting strip as set forth in claim 1, wherein the electrical conductors of the flexible electrically insulated cable include a series electrical conductor, and each lighting unit further comprises:
a first terminating sub-unit including insulation displacing conductors electrically contacting at least the first power conductor and the series electrical conductor of the plurality of spaced apart parallel electrical conductors, and
a second terminating sub-unit including insulation displacing conductors electrically contacting at least the second power conductor and the series electrical conductor of the plurality of spaced apart parallel electrical conductors;
the power regulating electrical circuitry including power regulating circuitry disposed on the first or second terminating sub-unit to maintain a constant current along the portion of the series electrical conductor disposed between the first and second terminating sub-units.

9. The lighting strip as set forth in claim 8, wherein each lighting unit further comprises:
one or more series sub-units disposed between the first and second terminating sub-units, each series sub-unit including insulation displacing conductors electrically contacting the series electrical conductor and the series electrical conductor having an interruption corresponding to each series sub-unit that electrically isolates insulation displacing conductors of that series sub-unit from one another, each series connector having the constant current flowing therethrough and having at least one of the one or more light emitting devices disposed thereon.

10. The lighting strip as set forth in claim 9, wherein the series sub-units do not include power regulating electrical circuitry.

11. The lighting strip as set forth in claim 9, wherein each of the first and second terminating sub-units and the series sub-units comprises:
a connector supporting at least the insulation displacing conductors.

12. The lighting strip as set forth in claim 8, wherein the at least one series electrical conductor includes a plurality of series electrical conductors, and the at least one second terminating sub-unit includes a plurality of second terminating sub-units corresponding to the plurality of series electrical conductors, each second terminating sub-unit having insulation displacing conductors electrically contacting the second power conductor and the corresponding series electrical conductor.

13. The lighting strip as set forth in claim 1, wherein each lighting unit comprises:
a plurality of sub-units each including at least two insulation displacing conductors electrically contacting at least two different electrical conductors of the plurality of spaced apart parallel electrical conductors, the power regulating electrical circuitry maintaining a common and substantially constant electrical current flowing through each sub-unit of the lighting unit.

14. The lighting strip as set forth in claim 1, wherein the one or more light emitting devices of each lighting unit include a plurality of light emitting diodes emitting light of the same or different colors.

15. The lighting strip as set forth in claim 1, wherein the power regulating electrical circuitry of each lighting unit includes:
an integrated circuit power regulator component; and
at least one passive circuit element electrically communicating with the integrated circuit power regulator component.

16. The lighting strip as set forth in claim 1, wherein the insulation displacing conductors of each lighting unit comprise:
a plurality of insulation displacing conductors of the same shape contacting at least two different conductors of the spaced apart parallel electrical conductors

17. The lighting strip as set forth in claim 1, wherein the insulation displacing conductors of each lighting unit comprise:
a plurality of interchangeable insulation displacing conductors contacting at least two different conductors of the spaced apart parallel electrical conductors

18. A lighting strip comprising:
a flexible electrically insulated cable including a plurality of spaced apart parallel electrical conductors bound together by electrical insulation as a cable, the electrical conductors including at least first and second power conductors; and
a plurality of lighting units secured to and spaced apart along the flexible electrically insulated cable, each lighting unit including (i) one or more light emitting devices, and (ii) a plurality of interchangeable insulation displacing conductors connecting the lighting unit with at least the first and second power conductors.

19. The lighting strip as set forth in claim 18, wherein each lighting unit further comprises:
power regulating electrical circuitry configured to regulate electrical power delivered to the lighting unit from the power conductors of the cable.

20. The lighting strip as set forth in claim 19, wherein the plurality of spaced apart parallel electrical conductors of the flexible electrically insulated cable further comprise:
an electrically disjointed series electrical conductor, each lighting unit having a plurality of lighting sub-units series-interconnected by the electrically disjointed series electrical conductor.

21. The lighting strip as set forth in claim 18, wherein the plurality of interchangeable insulation displacing conductors of each lighting unit include interchangeable insulation displacing conductors that are relatively flipped to contact different conductors of the plurality of spaced apart parallel electrical conductors of the flexible electrically insulated cable.

22. The lighting strip as set forth in claim 18, wherein each lighting unit further comprises:
at least one printed circuit board on which at least one of (i) one of the light emitting devices and (ii) power regulating electrical circuitry is disposed, at least two of the interchangeable insulation displacing conductors connecting with the at least one printed circuit board.

23. The lighting strip as set forth in claim 22, wherein each interchangeable insulation displacing conductor includes a plurality of slots configured to electrically and mechanically mate with the at least one printed circuit board, different slots of the interchangeable insulation displacing conductors mating with the at least one printed circuit board so as to align the interchangeable insulation displacing conductors with different conductors of the plurality of spaced apart parallel electrical conductors of the flexible electrically insulated cable.

24. The lighting strip as set forth in claim 22, wherein the interchangeable insulation displacing conductors include N slots configured to electrically and mechanically mate with the at least one printed circuit board, the interchangeable insulation displacing conductors being connectable with at least N+1 conductors of the plurality of spaced apart parallel electrical conductors of the flexible electrically insulated cable by using different slots and selective flipping of the interchangeable insulation displacing conductors.
